(19) United States
(12) Patent Application Publication
(10) Pub. No.: US 2025/0339814 A1
(43) Pub. Date: Nov. 6, 2025

(54) METHOD AND COMPOSITION FOR CARBON CAPTURE AND STORAGE

(71) Applicant: Bal Mukund Dhar, Lincoln, MA (US)

(72) Inventor: Bal Mukund Dhar, Lincoln, MA (US)

(21) Appl. No.: 19/199,364

(22) Filed: May 5, 2025

Related U.S. Application Data
(60) Provisional application No. 63/642,142, filed on May 3, 2024.

(51) Int. Cl. B01D 53/62; B01D 53/78; B01D 53/96

(52) U.S. Cl. CPC B01D 53/62; B01D 53/78; B01D 53/96; B01D 2251/30; B01D 2251/606; B01D 2252/204; B01D 2252/602

(57) ABSTRACT

Embodiments described in this disclosure pertain to catalytic or promotion methodologies for the reactive absorption of carbon dioxide (CO2) from ambient air or other gas streams comprising CO₂ into alkali metal carbonates, particularly sodium carbonate or sodium carbonate bearing minerals like trona. Key aspects include the utilization of fully carbonated amines, amine carbamates, or carbamate salts as promoter to expedite the reaction between CO₂ and alkali metal carbonates, alongside formulations and reactor designs aimed at optimizing CO₂ capture efficiency.

### CROSS-REFERENCE TO RELATED APPLICATIONS

This application is a Utility Patent application claiming priority to U.S. Provisional Patent Application Ser. No. 63/642,142, filed on May 3, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of capture of CO₂, and more specifically to a catalytic or promotion approaches to reactive absorption of CO₂ from ambient air, or other gaseous streams comprising CO₂ into alkali metal carbonates, particularly sodium carbonate or sodium carbonate bearing minerals like trona.

### 2) Description of related art

Alkali metal carbonates such as potassium carbonate and sodium carbonate have been explored as candidate for capture of CO₂ from industrial emission sources. Sodium carbonate, commonly known as soda ash, has garnered greater attention as a potential sorbent material for carbon capture and direct air capture (DA C) due to its abundance, low cost, and environmentally friendly properties. Sodium Carbonate occurs naturally in water soluble mineral Trona (Sodium Sesquicarbonate-Na₂CO3.NaHCO₃.2H₂O). Major reserves of trona are found in Wyoming, USA.

In carbon capture applications, sodium carbonate can react with flue gas emissions from industrial processes, such as power plants and cement kilns, to form stable carbonate compounds. This reaction, known as carbonation, involves the reactive absorption of CO₂ into sodium carbonate solution or slurry, resulting in the formation of sodium bicarbonate (NaHCO₃) or Sodium Sesquicarbonate (Na₂CO₃.NaHCO₃.2H₂O).

Direct air capture (DA C) of CO₂ using sodium carbonate (Na₂CO₃) as a sorbent material presents both opportunities and challenges in the quest to mitigate climate change. While sodium carbonate offers certain advantages such as its abundance, low cost, and environmentally benign nature, several challenges must be addressed to realize its full potential for CO₂ capture from the atmosphere.

One of the challenges associated with sodium carbonate-based DA C is the slow kinetics of the carbonation reaction. The rate at which sodium carbonate reacts with CO₂ to form sodium bicarbonate depends on factors such as temperature, pressure, and the concentration of CO₂ in the air. In ambient conditions, the carbonation reaction may proceed slowly, leading to inefficient CO₂ capture and requiring longer contact times between the sorbent material and air. Improving the kinetics of the carbonation reaction is essential for enhancing the efficiency and performance of sodium carbonate-based DAC systems.

Despite these challenges, ongoing research and development efforts are focused on addressing the limitations of sodium carbonate-based DA C systems. Strategies such as optimizing process conditions, enhancing sorbent properties, and integrating unique reactor designs hold promise for improving the efficiency, scalability, and cost-effectiveness of DA C technology using sodium carbonate. By overcoming these challenges, sodium carbonate-based DAC has the potential to play a significant role in reducing greenhouse gas emissions and combating climate change on a global scale.

### BRIEF SUMMARY OF THE INVENTION

Embodiments described herein relate to catalytic or promotion approaches for reactive absorption of CO₂ into alkali metal carbonates wherein the alkali metal is at least one of lithium, sodium, potassium, cesium, or combinations thereof. Embodiments described herein also relate to catalytic or promotion approaches for reactive absorption of CO₂ from ambient air or other sources with low CO₂ concentration into sodium carbonate, or sodium carbonate bearing minerals such as trona.

Embodiments described herein also relate to simultaneous reactive absorption and mineralization of CO₂ into a sodium carbonate bearing mineral. Embodiments described herein also relate to materials and formulations to enhance the capture CO₂ in solutions comprising alkali metals carbonates, thereby converting them into alkali metal bicarbonates either in solution or as a precipitate.

Embodiments described herein further relate to performing Direct Air Capture (DAC) of CO₂. Embodiments described herein further relate to unique materials and formulations to enhance the capture of CO₂ from gas mixtures. Embodiments described herein relate to capture of CO₂ thereby converting the mineral trona or its components in solution into sodium bicarbonate either in solution or as a precipitate.

Embodiments described herein further relate to use of a unique promoter to capture CO₂ into sodium carbonate converting it into sodium bicarbonate or sodium sesquicarbonate. The capture process may either be done in solution or in solid state. When the process is done in solution, the product sodium bicarbonate, sodium sesquicarbonate or their combination may remain dissolved in solution or form a precipitate.

Embodiments described herein further relate to simultaneous capture of CO₂ from gas mixtures and its chemical storage in mineral trona or its components in solution. Embodiments described herein also relate to unique materials and formulations to enhance the capture CO₂ in solutions comprising alkali metals carbonates, thereby converting them into alkali metal bicarbonates either in solution or as a precipitate. Embodiments described herein also relate to use of unique materials and formulations to enhance the simultaneous capture of CO₂ from gas mixtures and its chemical storage in minerals forming solid products.

Embodiments described herein also relate to the use of an amine carbamate (formed by carbonation of an amine) as a promoter to enhance the capture of CO₂ into alkali metal carbonates. In some embodiments, a solution of fully carbonated amine in water is used to enhance the capture of CO₂ into alkali metal carbonates. In some embodiments, the solution of fully carbonated amine in water comprises carbamate ions, and bicarbonate ions formed as a result of hydrolysis of carbamate ions in water.

Embodiments disclosed herein further relate to a method of reactive absorption of CO₂ from gas mixtures, the method comprising: mixing a solution comprising alkali metal carbonate with a fully carbonated amine to form a solution mixture; and reacting a portion of the solution mixture with an input gas mixture comprising CO₂.

In some embodiments, the fully carbonated amine enhances the rate of reactive absorption of CO₂ into the alkali metal carbonate. In some embodiments, the amine is chosen from a list comprising monoethanolamine, diethanolamine, diglycolamine, methyldiethanolamine, 2-amino-2-methyl-1-propanol, diisopropanolamine, triethanolamine, and piperazine. In some embodiments, the percentage of CO₂ in the input gas mixture is in range between about 0.001% and about 50%. In some embodiments, the input gas mixture is ambient air.

In some embodiments, the alkali metal carbonate is at least one of sodium carbonate, potassium carbonate, or their combination. In some embodiments, the reaction of solution mixture with the input gas mixture leads to formation of a precipitate, the precipitate including alkali metal bicarbonate.

Embodiments disclosed herein further relate to a composition for reactive absorption of CO₂, the composition comprising: an aqueous solution of an alkali metal carbonate; and a promoter including a carbamate salt dissolved in the aqueous solution.

In some embodiments, the carbamate salt enhances the rate of reactive absorption of CO₂ into the alkali metal carbonate. In some embodiments, the carbamate anion of the carbamate salt includes at least one of a primary carbamate anion, a secondary carbamate anion, or a tertiary carbamate ion. In some embodiments, the cation of the carbamate salt includes a metal ion, a primary ammonium ion, a secondary ammonium ion, a tertiary ammonium ion, or a quaternary ammonium ion.

In some embodiments, the carbamate salt is formed by carbonation of an amine. In some embodiments, the amine is chosen from a list comprising monoethanolamine, diethanolamine, diglycolamine, methyldiethanolamine, 2-amino-2-methyl-1-propanol, diisopropanolamine, triethanolamine, and piperazine. In some embodiments, the promoter does not include any uncarbonated amine.

Embodiments disclosed herein also relate to a method of continuous capture and mineralization of CO₂, the method comprising: mixing a solution comprising trona with a fully carbonated amine to form a solution mixture; reacting the solution mixture with CO₂ in ambient air to form a suspension comprising a precipitate, the precipitate including sodium bicarbonate; filtering the suspension to separate at least a portion of the precipitate and form a filtered suspension; and recycling the filtered suspension to the solution mixture, and adding fresh trona solution to the solution mixture.

In some embodiments, the full carbonated amine enhances the rate of reactive absorption of CO₂ into the trona solution. In some embodiments, the full carbonated amine forms a carbamate anion in solution, the carbamate anion including a primary carbamate anion, a secondary carbamate anion, or a tertiary carbamate anion. In some embodiments, the full carbonated amine forms a cation in solution, the cation including a primary ammonium ion, a secondary ammonium ion, a tertiary ammonium ion, or a quaternary ammonium ion.

In some embodiments, the amine is chosen from a list comprising monoethanolamine, diethanolamine, diglycolamine, methyldiethanolamine, 2-amino-2-methyl-1-propanol, diisopropanolamine, triethanolamine, and piperazine. In some embodiments, the solution mixture does not include any uncarbonated amine.

Embodiments disclosed herein further relate to a method of continuous capture and mineralization of CO₂, the method comprising: mixing a solution comprising a sodium carbonate with a carbamate salt to form a solution mixture; reacting the solution mixture with CO₂ in an input gas mixture to form a suspension comprising a precipitate, the precipitate including at least one of sodium bicarbonate or sodium sesquicarbonate; filtering the suspension to separate at least a portion of the precipitate and form a filtered suspension; and recycling the filtered suspension to the solution mixture, and mixing additional solution comprising sodium carbonate to the solution mixture.

In some embodiments, the carbamate salt enhances the rate of reactive absorption of CO₂ into the alkali metal carbonate. In some embodiments, the carbamate anion of the carbamate salt includes at least one of a primary carbamate anion, a secondary carbamate anion, or a tertiary carbamate ion. In some embodiments, the cation of the carbamate salt includes a metal ion, a primary ammonium ion, a secondary ammonium ion, a tertiary ammonium ion, or a quaternary ammonium ion.

In some embodiments, the carbamate salt is formed by carbonation of an amine. In some embodiments, the amine is chosen from a list comprising monoethanolamine, diethanolamine, diglycolamine, methyldiethanolamine, 2-amino-2-methyl-1-propanol, diisopropanolamine, triethanolamine, and piperazine. In some embodiments, the solution mixture does not include any uncarbonated amine.

In some embodiments, the carbamate salt is formed by carbonation of an amino acid, or an amino acid salt. In some embodiments, the carbamate salt is formed by carbonation of cysteine, or a metal cysteinate.

Embodiments described herein also relate to a method of reactive absorption of CO₂ from gas mixtures, the method comprising: mixing a solution comprising alkali metal carbonate and a solution comprising an amine carbamate to form a solution mixture; and reacting a portion of the solution mixture with a gas mixture comprising CO₂. In some embodiments, the amine carbamate increases the rate of reaction between the alkali metal carbonate in the solution mixture and the CO₂ in the gas mixture.

In some embodiments, the percentage of CO₂ in the gas mixture is in the range between 0.001% and 20%. In some embodiments, the gas mixture is ambient air. In some embodiments, the gas mixture is an exhaust from at least one of a coal power plant, a natural gas power plant, or an industrial process. In some embodiments, the gas mixture is a natural gas output from a geological reservoir. In some embodiments, the gas mixture is the output of a Steam Methane Reforming process.

In some embodiments, the concentration of alkali metal carbonate in the solution mixture is between about 1% and about 50% by weight. In some embodiments, the concentration of amine carbamate in the solution mixture is between about 0.01% and about 95%. In some embodiments, the solution comprising amine carbamate does not contain any uncarbonated amine. In some embodiments, the solution comprising amine carbamate includes water in the range between about 0.1% and 99%.

In some embodiments, the solution mixture comprises water in the range between about 0.1% and 99%. In some embodiments, the solution mixture comprises at least one of ethylene glycol, propylene glycol, glycerol, propylene carbonate, choline chloride, a eutectic mixture of choline chloride with urea, or combinations thereof.

In some embodiments, the solution mixture further comprises at least one of sodium chloride, potassium chloride, lithium chloride, sodium sulfate, or potassium sulfate. In some embodiments, the solution mixture further comprises seed particles to facilitate the precipitation of sodium bicarbonate from solution. In some embodiments, the solution mixture further comprises seed particles, the seed particles including at least one of sodium bicarbonate, calcium carbonate, magnesium carbonate, silica, an aluminosilicate, calcium silicate, magnesium silicate, or a metal silicate mineral such as basalt, serpentine, olivine, peridotite, pyroxene, plagioclase, wollastonite etc.

In some embodiments, the alkali metal carbonate is sodium carbonate. In some embodiments, the solution comprising sodium carbonate is formed by dissolving the mineral trona in water. In some embodiments, the solution comprising sodium carbonate is formed by dissolving another mineral comprising sodium carbonate. In some embodiments, the solution comprising sodium carbonate is formed by dissolving sodium sesquicarbonate in water. In some embodiments, the solution comprising sodium carbonate further includes an equal or lower concentration of sodium bicarbonate in solution.

In some embodiments, the reaction of solution mixture with the gas mixture leads to formation of a precipitate comprising sodium bicarbonate. In some embodiments, the reaction of solution mixture with the gas mixture leads to formation of a precipitate comprising at least one of sodium bicarbonate, sodium sesquicarbonate, or combinations thereof.

In some embodiments, the solution comprising sodium carbonate is obtained by solution mining of a mineral bedrock comprising trona. In some embodiments, the mineral bedrock comprising trona may further include other minerals such as a halite, shortite, nahcolite, wegscheiderite, a sodium sulfate bearing mineral, or combinations thereof. In some embodiments, the mineral bedrock comprising trona further includes marlstone, oil shale, and mudstone.

In some embodiments, the mineral bedrock comprising sodium carbonate further includes a borate compound, an arsenate compound, a vanadate compound, or combinations thereof. In some embodiments, the minerals and compounds found alongside the sodium carbonate mineral are water soluble. In some embodiments, the minerals and compounds found alongside the sodium carbonate mineral enhance the rate of reactive absorption of CO₂ into the solution formed by dissolving the sodium carbonate mineral.

Embodiments described herein also relate to a method of reactive absorption of CO₂ from gas mixtures, the method comprising: mixing a solution comprising a fully carbonated amine with a solution comprising sodium carbonate to form a solution mixture; reacting the solution mixture with ambient air to form a suspension comprising a precipitate, the precipitate including at least one of sodium bicarbonate, sodium sesquicarbonate, or their combination; filtering the suspension to separate at least a portion of the precipitate; and repeating the process by recycling the filtered suspension to the solution mixture, and adding a fresh solution comprising sodium carbonate to the solution mixture. In some embodiments, the solution comprising fully carbonated amine further includes a borate compound, a vanadate compound, an arsenate compound, an ionic liquid promoter, an amino acid, a salt of an amino acid, carbonic anhydrase enzyme, or combinations thereof.

Embodiments described herein also relate to a method of simultaneous capture and mineralization of CO₂, the method comprising: mixing a solution comprising fully carbonated amine with a trona solution to form a solution mixture; reacting the solution mixture with CO₂ in ambient air to form a suspension comprising a precipitate, the precipitate including at least one of sodium bicarbonate, sodium sesquicarbonate, or their combination; filtering the suspension to separate at least a portion of the precipitate and form a filtered suspension; and repeating the process by recycling the filtered suspension to the solution mixture, and adding fresh trona solution to the solution mixture. In some embodiments, the solution comprising fully carbonated amine further includes a borate compound, a vanadate compound, an arsenate compound, an ionic liquid promoter, an amino acid, a salt of an amino acid, carbonic anhydrase enzyme, or combinations thereof. In some embodiments, the solution mixture does not have any uncarbonated amine.

Embodiments described herein also relate to a method of producing carbon negative sodium bicarbonate, the method comprising: mixing a solution comprising a fully carbonated amine with a solution comprising sodium carbonate to form a solution mixture; reacting the solution mixture with ambient air to form a suspension comprising a precipitate, the precipitate including sodium bicarbonate; filtering the suspension to separate at least a portion of the precipitate; washing the filtered precipitate with a solvent to remove impurities. In some embodiments, the solution comprising fully carbonated amine further includes a borate compound, a vanadate compound, an arsenate compound, an ionic liquid promoter, an amino acid, a salt of an amino acid, carbonic anhydrase enzyme, or combinations thereof. In some embodiments, the solution mixture does not have any uncarbonated amine.

Embodiments described herein relate to a composition for capture of CO₂, the composition comprising: a solution comprising water; a promoter comprising amine carbamate; and an alkali metal carbonate dissolved in the solution. In some embodiments, the alkali metal carbonate may be sodium carbonate, potassium carbonate, or combinations thereof.

In some embodiments, the promoter further includes a borate compound, a vanadate compound, an arsenate compound, an ionic liquid promoter, an amino acid, a salt of an amino acid, carbonic anhydrase enzyme, or combinations thereof. In some embodiments, the promoter does not include any uncarbonated amine.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a block diagram of a process for reactive absorption of CO₂, according to an embodiment.

FIG. 2 shows a process flow diagram of a continuous process for reactive absorption and mineralization of CO₂ from an incoming gas mixture, according to an embodiment.

FIG. 3 shows a block diagram of a continuous process for reactive absorption and mineralization of CO₂ from an incoming gas mixture, according to an embodiment.

FIG. 4 shows a process flow diagram of a carbon capture process for production of an output gas stream comprising a high concentration of CO₂, according to an embodiment.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms catalyst and promoter are used interchangeably to mean a compound, ion, or ion-pair, which in a solution or as a solid, enhances the rate of reactive absorption of CO₂.

Direct Air Capture of CO₂ (DAC) using sodium carbonate or other alkali metal carbonates has not been feasible due to kinetics. Mixing sodium carbonate with amine compounds and other promoters has been demonstrated as an effective solution in literature for CO₂ capture from power plants and other industrial sources. However, these approaches do not work well when the CO₂ concentration is low, for instance air. A mines evaporate during the carbon capture process due to their intrinsic volatility. This is manageable for carbon capture from industrial emissions and power plant flue gases since the CO₂ percentage is higher (10-20%), and therefore a closed system can be designed so that the evaporated amines are recovered from the exhaust of the carbonation step in a subsequent step. However, DA C is performed as an open system with a high volume of air flow needed (˜2 million m³/ton CO₂), which leads to a significant loss of amine via evaporation with a single capture cycle.

Embodiments disclosed herein relate to the use of amine carbamate as a promoter in carbonation of alkali metal carbonates (e.g. sodium carbonate or potassium carbonate) or solutions comprising alkali metal carbonates. The amine carbamate is formed by carbonation of the corresponding amine before being mixed with alkali metal carbonate for the reactive capture of CO₂.

In some embodiments, the amine is fully carbonated before being used as a promoter for carbonation of the alkali metal carbonate. In some embodiments, the carbonation of amine is performed in an aqueous solution. In some embodiments, a portion of the amine carbamate formed by the carbonation of amine hydrolyses in the aqueous solution to form bicarbonate ions and the corresponding N⁺ ion. A key advantage of this approach is that the promoter can be produced at low cost and large scale by simple carbonation of amines which are widely available.

The amine carbamate formed by carbonation of amine is in ionic form is therefore non-volatile. The use of a fully carbonated amine, or an aqueous solution of a fully carbonated amine is a counterintuitive approach to the reactive absorption of CO₂ since it is expected that the CO₂ absorption capacity of an amine is spent once it has been fully carbonated and converted to amine carbamate (and bicarbonate/carbonate ions and corresponding N⁺ ions after undergoing hydrolysis in an aqueous solution). On the contrary, the fully carbonated amine as amine carbamate (including the carbonate/bicarbonate ions and corresponding N⁺ ions) is effective in catalyzing reactive absorption of CO₂ with an alkali metal carbonate or a solution comprising alkali metal carbonate.

In some embodiments, a fully carbonated amine enhances the rate of reactive absorption of a dilute stream of CO₂ (such as air) in a solution comprising sodium carbonate leading to the formation of sodium bicarbonate. In some embodiments, the sodium bicarbonate so formed may precipitate out of the solution. In some embodiments, the solution comprising sodium carbonate is formed by dissolving a mineral comprising trona in water.

Embodiments described herein further relate to a method of capture and simultaneous chemical storage of CO₂ in trona solution to form a precipitate comprising sodium bicarbonate, wherein the rate of reactive absorption of CO₂ in a trona solution is enhanced by a fully carbonated amine. The sodium bicarbonate precipitate so formed is carbon-negative when the source of CO₂ is ambient air. In some embodiments, the precipitate comprises at least one of sodium bicarbonate, sodium sesquicarbonate or combinations thereof.

In some embodiments, the amine carbamate is so chosen that the pKa of the amine group of the corresponding amine is lower than the pH of the alkali metal carbonate solution. This may be due to the fact that the carbamate anion is stable above the pKa of the amine group in the particular amine. As the reactive carbonation of the alkali metal carbonate solution proceeds, the pH of the solution continues to drop. In some embodiments, the amine is so chosen that the pKa of the amine group is low enough to maintain a catalytic/promoter effect even after the sufficient lowering of the pH of the solution due to the reactive carbonation of alkali metal carbonate.

In some embodiments, a carbamate salt is used as a promoter to enhance the rate of reactive capture of CO₂ into alkali metal carbonate or a solution comprising alkali metal carbonate. In some embodiments, the carbamate anion of the carbamate salt includes at least one of a primary carbamate anion, a secondary carbamate anion, or a tertiary carbamate ion. In other words, the nitrogen atom (N-atom) in the carbamate anion is a primary, a secondary, or a tertiary N-atom. In some embodiments, the cation of the carbamate salt includes a metal ion, a primary ammonium ion, a secondary ammonium ion, a tertiary ammonium ion, or a quaternary ammonium ion. In some embodiments, the metal ion in the carbamate salt is an ion of an alkali metal (e.g. Na, K, Li), alkaline earth metal (e.g. M g, Ca), 3^{rd} group (e.g. Al) or a transition metal (e.g. Cu, Zn, Sn etc.)

In some embodiments, the carbamate salt is formed by carbonation of an amine. In some embodiments, the amine is chosen from a list comprising monoethanolamine, diethanolamine, diglycolamine, methyldiethanolamine, 2-amino-2-methyl-1-propanol, diisopropanolamine, triethanolamine, and piperazine. In some embodiments, the promoter does not include any uncarbonated amine.

Embodiments disclosed herein relate to a method of continuous capture and mineralization of CO₂, the method comprising: mixing a solution comprising a sodium carbonate with a carbamate salt to form a solution mixture; reacting the solution mixture with CO₂ in an input gas mixture to form a suspension comprising a precipitate, the precipitate including at least one of sodium bicarbonate or sodium sesquicarbonate; filtering the suspension to separate at least a portion of the precipitate and form a filtered suspension; and recycling the filtered suspension to the solution mixture, and mixing additional solution comprising sodium carbonate to the solution mixture.

In some embodiments, the carbamate salt enhances the rate of reactive absorption of CO₂ into the alkali metal carbonate. In some embodiments, the carbamate anion of the carbamate salt includes at least one of a primary carbamate anion, a secondary carbamate anion, or a tertiary carbamate ion. In other words, the nitrogen atom (N-atom) in the carbamate anion is a primary, a secondary, or a tertiary N-atom. In some embodiments, the cation of the carbamate salt includes a metal ion, a primary ammonium ion, a secondary ammonium ion, a tertiary ammonium ion, or a quaternary ammonium ion. In some embodiments, the metal ion in the carbamate salt is an ion of an alkali metal (e.g. Na, K, Li), alkaline earth metal (e.g. M g, Ca), 3^{rd} group (e.g. Al) or a transition metal (e.g. Cu, Zn, Sn etc.)

In some embodiments, the carbamate salt is formed by carbonation of an amine. In some embodiments, the amine is chosen from a list comprising monoethanolamine, diethanolamine, diglycolamine, methyldiethanolamine, 2-amino-2-methyl-1-propanol, diisopropanolamine, triethanolamine, and piperazine. In some embodiments, the solution mixture does not include any uncarbonated amine.

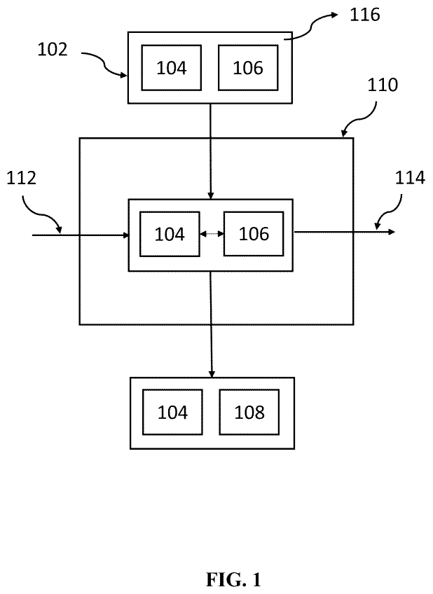

FIG. 1 shows a block diagram of a process for reactive absorption of CO₂ from an input gas mixture. The system comprises a reactor unit 110 through which a liquid sorbent 102 flows, while reacting with CO₂ in the incoming gas mixture 112. As a result of the reaction with the liquid sorbent 102, the exhaust gas mixture 114 that leaves the reactor unit 110 has lower CO₂ content compared to the incoming gas mixture 112.

The liquid sorbent 102 comprises a promoter 104 and a reactant 106 mixed in a solution 116. The promoter 104 and the reactant 106 work synergistically to accelerate the capture of CO₂ in the incoming gas mixture 112 into the liquid sorbent 102. In some embodiments, the promoter 104 is an amine carbamate and the reactant 106 is an alkali metal carbonate and the solution 116 comprises water.

The promoter 104 may be in the range between about 0.001% and about 50% of the liquid sorbent 102 by weight. The reactant 106 may be in the range between about 1% and about 50% of the liquid sorbent 102 by weight. The amount of water in the sorbent 102 may be in the range between about 5% and about 90% by weight.

Promoter 104: In some embodiments, promoter 104 comprises a fully carbonated amine in solution comprising amine carbamate (anion), protonated amine, bicarbonate ions and carbonate ions. In some embodiments, the promoter 104 comprises fully carbonated amine and does not include any unreacted or uncarbonated amine. The embodiments in this disclosure follow the discovery that a fully carbonated amine acts as a promoter to accelerate the reaction of sodium carbonate solution with gas mixtures comprising low concentration of CO₂, for instance ambient air.

In some embodiments, promoter 104 is a carbonated primary amine, a carbonated secondary amine, a carbonated tertiary amine, a carbonated aromatic amine, carbonated heterocyclic nitrogen containing compound, carbonated piperidine, carbonated piperazine or a combination thereof. In some embodiments, the promoter 104 is a fully carbonated versions of at least one of the following amines: M ethanolamine (MEA), Diethanolamine (DEA), Methyldiethanolamine (MDEA), Triethanolamine (TEA), Ethylenediamine, Diglycolamine (DGA), 2-amino-2-methyl-1-propanol (AMP), Diisopropanolamine (DIPA), Piperidine, Piperazine or combinations thereof. In some embodiments, the promoter 104 is a fully carbonated Polyamine. In some embodiments, the solution mixture does not include any uncarbonated amine.

In some embodiments, the promoter 104 is a carbamate salt. In some embodiments, the carbamate salt is formed by carbonation of an amine, an amino acid, or an amino acid salt. In some embodiments, the carbamate anion of the carbamate salt includes at least one of a primary carbamate anion, a secondary carbamate anion, or a tertiary carbamate ion. In other words, the nitrogen atom (N-atom) in the carbamate anion is a primary, a secondary, or a tertiary N-atom. In some embodiments, the cation of the carbamate salt includes a metal ion, a primary ammonium ion, a secondary ammonium ion, a tertiary ammonium ion, or a quaternary ammonium ion. In some embodiments, the metal ion in the carbamate salt is an ion of an alkali metal (e.g. Na, K, Li), alkaline earth metal (e.g. M g, Ca), 3^{rd} group (e.g. Al) or a transition metal (e.g. Cu, Zn, Sn etc.). In some embodiments, the carbamate salt is formed by carbonation of cysteine, or a metal cysteinate.

In some embodiments, the promoter 104 is a Metal Carbamate. In some embodiments the promoter 104 includes at least one of Potassium Carbamate, Sodium Carbamate, Lithium Carbamate, Magnesium Carbamate, Calcium Carbamate, or a combination thereof.

In some embodiments, the carbonated amine hydrolyzes in aqueous solution to form at least one of organo-carbamate ion, an organo-ammonium ion, a bicarbonate ion, and a carbonate ion. In some embodiments, the bicarbonate ions in solution combines with sodium ions in solution to form a sodium bicarbonate precipitate.

In some embodiments, the promoter 104 comprises a carbonated amino acid. In some embodiments, the entirety of amino acid in the liquid sorbent 102 is carbonated. In some embodiments, the promoter 104 includes a carbonated salt of at least one of glycine, sarcosine, proline, arginine, lysine, valine, isoleucine, leucine, glutamine, alanine, threonine, histidine, phenylalanine, tyrosine, tryptophan, serine, cysteine, aspartic acid, glutamic acid, methionine, a branched amino acid, or an amino acid derivative.

In some embodiments, the promoter 104 is a carbonated metal salt of an amino acid. In some embodiments, the entirety of a carbonated metal salt of an amino acid in the liquid sorbent 102 is carbonated. In some embodiments, the promoter 104 included a carbonated version of at least one of glycine, sarcosine, proline, arginine, lysine, valine, isoleucine, leucine, glutamine, alanine, threonine, histidine, phenylalanine, tyrosine, tryptophan, serine, cysteine, aspartic acid, glutamic acid, methionine, a branched amino acid, or an amino acid derivative.

In some embodiments, the amount of promoter 104 in liquid sorbent 102 is in the range between about 0.001% and about 50% by weight. In some embodiments, the amount of promoter 104 in liquid sorbent 102 is in the range between about 0.001% and about 0.1% by weight. In some embodiments, the amount of promoter 104 in liquid sorbent 102 is in the range between about 0.1% and about 1% by weight. In some embodiments, the amount of promoter 104 in liquid sorbent 102 is in the range between about 1% and about 5% by weight. In some embodiments, the amount of promoter 104 in liquid sorbent 102 is in the range between about 5% and about 10% by weight. In some embodiments, the amount of promoter 104 in liquid sorbent 102 is in the range between about 10% and about 20% by weight. In some embodiments, the amount of promoter 104 in liquid sorbent 102 is in the range between about 20% and about 50% by weight.

In some embodiments, the amount of promoter 104 in liquid sorbent 102 is at least 1% by weight. In some embodiments, the amount of promoter 104 in liquid sorbent 102 is at least 5% by weight. In some embodiments, the amount of promoter 104 in liquid sorbent 102 is at least 10% by weight. In some embodiments, the amount of promoter 104 in liquid sorbent 102 is at least 20% by weight. In some embodiments, the amount of promoter 104 in liquid sorbent 102 is at least 30% by weight. In some embodiments, the amount of promoter 104 in liquid sorbent 102 is at least 40% by weight.

In some embodiments, the promoter 104 is a liquid at the temperature of operation of the reactor unit 110.

Reactant 106: The reactant 106 is a material that reacts with CO₂ to form a product 108. In some embodiments, the reactant 106 is a sodium carbonate in solution. In some embodiments the reactant 106 is potassium carbonate. In some embodiments the reactant 106 is a solution of sodium sesquicarbonate in water. In some embodiments, the reactant 106 is a solution of a mineral comprising trona in water. In some embodiments, the reactant 106 comprises an alkali metal ion and a carbonate counterion in solution.

In some embodiments, the reactant 106 is a mineral in solution which reacts with CO₂ to form the product 108. In some embodiments, the mineral in solution comprises an alkali metal ion, carbonate ions, and bicarbonate ions. In some embodiments the reactant 106 is a mineral slurry.

In some embodiments, reactant 106 raises the pH of the solution to a value between about 8.5 and about 11. In some embodiments the solution of reactant 106 raises the pH to a value between about 11 and about 12. In some embodiments the solution of reactant 106 raises the pH to a value between about 12 and about 13.

In some embodiments the pH of the solution comprising the reactant 106 and promoter 104 is at least 9. In some embodiments the PH of the solution comprising the reactant 106 and promoter 104 is at least 10. In some embodiments the pH of the solution comprising the reactant 106 and promoter 104 is at least 11. In some embodiments the PH of the solution comprising the reactant 106 and promoter 104 is at least 12. In some embodiments the pH of the solution comprising the liquid sorbent 102 comprising reactant 106 and promoter 104 is in the range between about 8.5 and 10. In some embodiments the pH of the solution comprising the liquid sorbent 102 comprising reactant 106 and promoter 104 is in the range between about 10 and about 11. In some embodiments the pH of the solution comprising the liquid sorbent 102 comprising reactant 106 and promoter 104 is in the range between about 11 and about 12. In some embodiments the pH of the solution comprising the liquid sorbent 102 comprising reactant 106 and promoter 104 is in the range between about 12 and about 13.

In some embodiments, the amount of reactant 106 in liquid sorbent 102 is in the range between about 0.1% and about 50% by weight. In some embodiments, the amount of reactant 106 in liquid sorbent 102 is in the range between about 0.1% and about 1% by weight. In some embodiments, the amount of reactant 106 in liquid sorbent 102 is in the range between about 1% and about 5% by weight. In some embodiments, the amount of reactant 106 in liquid sorbent 102 is in the range between about 5% and about 10% by weight. In some embodiments, the amount of reactant 106 in liquid sorbent 102 is in the range between about 10% and about 20% by weight. In some embodiments, the amount of reactant 106 in liquid sorbent 102 is in the range between about 20% and about 50% by weight.

In some embodiments, the amount of reactant 106 in liquid sorbent 102 is at least 1% by weight. In some embodiments, the amount of reactant 106 in liquid sorbent 102 is at least 5% by weight. In some embodiments, the amount of reactant 106 in liquid sorbent 102 is at least 10% by weight. In some embodiments, the amount of reactant 106 in liquid sorbent 102 is at least 20% by weight. In some embodiments, the amount of reactant 106 in liquid sorbent 102 is at least 30% by weight.

In some embodiments, when the liquid sorbent 102 comprises sodium carbonate as reactant 106 dissolved in the solution 116, the reaction with CO₂ in the incoming gas mixture 112 leads to the formation of sodium bicarbonate as product 108. In some embodiments, sodium bicarbonate so formed remains in solution as sodium ions and bicarbonate ions. In some embodiments the sodium bicarbonate formed as product 108 precipitates out of the solution as a solid.

In some embodiments, the reactant 106 is a solution comprising alkali metal ions, carbonate ions, a bicarbonate ion as part of reactant 106. In some embodiments, the alkali metal ions in the reactant 106 are at least one of sodium, potassium, lithium or a combination thereof.

Solution 116: In some embodiments the solution 116 comprises the promoter 104 and reactant 106 dissolved in it. In such cases, the promoter 104 and the reactant 106 exist as ions in the solution 116. In some embodiments, the solution 116 is an aqueous solution. In some embodiments, the solution 116 is a multicomponent system comprising at least one of water, ethanol, methanol, ethylene glycol, propylene glycol, glycerol, propylene carbonate, choline chloride, eutectic mixture of urea with choline chloride, or their combinations. In some embodiments, the solution 116 is a solution of water and at least one organic solvent miscible with water. In some embodiments, the solution 116 is a mixture of water and at least one organic solvent immiscible with water.

In some embodiments, one of promoter 104 or reactant 106 is preferentially soluble in one of the components of the solution 116. In some embodiments, one of promoter 104 or reactant 106 is insoluble in one of the components of the solution 116. In some embodiments, one of promoter 104 or reactant 106 is more soluble in one of the components of the solution 116. In some embodiments, the promoter 104 being in liquid state is miscible with the solution 116. In some embodiments, the promoter 104 being in liquid state is miscible with at least one of the components of solution 116.

In some embodiments, the solution 116 comprises an additive 118. In some embodiments, the additive 118 is a metal salt soluble in solution 116. In some embodiments, the additive 118 is at least one of sodium chloride, magnesium chloride, calcium chloride, potassium chloride, lithium chloride, sodium sulfate, potassium sulfate, or a combination thereof. In some embodiments, the additive 118 is a soluble metal salt including at least one of a metal nitrate, a metal sulfate, a metal chloride, or a metal acetate. In some embodiments, the concentration of metal salt in solution is between about 1% and about 25% by weight. In some embodiments, the concentration of the metal salt in solution is between about 1% and about 30% by weight. In some embodiments, the concentration of metal salt in solution is between about 5% and about 25% by weight. In some embodiments, the concentration of metal salt in solution is between about 10% and about 20% by weight. In some embodiments, the concentration of metal salt in solution is between about 12% and about 15% by weight.

In some embodiments, the additive 118 is a surfactant. In some embodiments, the addition of surfactant to solution 116 helps in precipitation of alkali metal bicarbonate (such as sodium bicarbonate) from the solution. In some embodiments, the surfactant is sodium dodecyl benzene sulfonate. In an exemplary embodiment, the sodium dodecyl sulfonate as a surfactant aids the precipitation of sodium bicarbonate from solution.

In some embodiments, the concentration of the surfactant in liquid sorbent 102 is between about 10 ppm and about 30000 ppm by weight. In some embodiments, the concentration of the surfactant in liquid sorbent 102 is between about 100 ppm and about 5000 ppm by weight. In some embodiments, the concentration of the surfactant in liquid sorbent 102 is between about 100 ppm and about 1000 ppm by weight. In some embodiments, the concentration of the surfactant in liquid sorbent 102 is between about 100 ppm and about 500 ppm by weight. In some embodiments, the concentration of the surfactant in liquid sorbent 102 is between about 200 ppm and about 500 ppm by weight. In some embodiments, the additive enhances the rate of reaction of CO₂ in the incoming gas mixture 112 with the liquid sorbent 102.

Product 108: In some embodiments, the product 108 is an alkali metal bicarbonate, for example sodium bicarbonate. In some embodiments, the alkali metal bicarbonate precipitates out of solution 116. In some embodiments, the product 108 is a carbonate of alkaline earth metal when the reactant 106 is either a hydroxide of an alkaline earth metal or a metal silicate. In some embodiments, the product 108 is at least one of calcium carbonate or magnesium carbonate.

Incoming gas mixture 112: The incoming gas mixture 112 can be direct air or a flue gas stream from a power plant, or another industrial process. In some embodiments, the incoming gas mixture is natural gas from an underground or geological natural gas reservoir comprising CO₂. In some embodiments, the gas mixture is the output of a Steam Methane Reforming process. In some embodiments, the gas mixture is an output of an electrochemical process.

In some embodiments, in addition to CO₂, the incoming gas mixture further comprises at least one of oxygen, nitrogen, natural gas, hydrogen, moisture, or combination thereof. In some embodiments the CO₂ concentration in the incoming gas mixture 112 is between about 0.001% and about 50% by weight. In some embodiments the CO₂ concentration in the incoming gas mixture 112 is between about 0.01% and about 0.1% by weight. In some embodiments the CO₂ concentration in the incoming gas mixture 112 is between about 0.1% and about 1% by weight.

In some embodiments the CO₂ concentration in the incoming gas mixture 112 is between about 1% and about 10% by weight. In some embodiments the CO₂ concentration in the incoming gas mixture 112 is between about 5% and about 20% by weight. In some embodiments the CO₂ concentration in the incoming gas mixture 112 is between about 5% and about 30% by weight. In some embodiments the CO₂ concentration in the incoming gas mixture 112 is between about 10% and about 50% by weight. In some embodiments, the incoming gas mixture 112 is ambient air having a CO₂ concentration in between about 0.03% and about 0.05% by weight.

In some embodiments, the incoming gas mixture 112 has a moisture content between about 0.001% to about 10% by weight. In some embodiments, the moisture content of the air enhances the rate of reaction of CO₂ in the incoming gas mixture 112 with the liquid sorbent 102. In some embodiments, the ambient air is mixed with water vapor or a gas mixture comprising air to create the incoming gas mixture 112.

Exhaust gas mixture 114: The exhaust gas mixture 114 that leaves the reactor unit 110 has a CO₂ concentration lower than that in the incoming gas mixture 112. In other words, the ratio of CO₂ concentration in the exhaust gas mixture 114 to the CO₂ concentration in the incoming gas mixture 112 is less than 1. In some embodiments, the ratio of CO₂ concentration in the exhaust gas mixture 114 to the CO₂ concentration in the incoming gas mixture 112 is between about 0.01 and about 0.99. In some embodiments, the ratio of CO₂ concentration in the exhaust gas mixture 114 to the CO₂ concentration in the incoming gas mixture 112 is between about 0.1 and about 0.9. In some embodiments, the ratio of CO₂ concentration in the exhaust gas mixture 114 to the CO₂ concentration in the incoming gas mixture 112 is between about 0.2 and about 0.8. In some embodiments, the ratio of CO₂ concentration in the exhaust gas mixture 114 to the CO₂ concentration in the incoming gas mixture 112 is between about 0.2 and about 0.4. In some embodiments, the ratio of CO₂ concentration in the exhaust gas mixture 114 to the CO₂ concentration in the incoming gas mixture 112 is between about 0.4 and about 0.6. In some embodiments, the ratio of CO₂ concentration in the exhaust gas mixture 114 to the CO₂ concentration in the incoming gas mixture 112 is between about 0.6 and about 0.8.

In some embodiments the exhaust gas mixture 114 does not contain any promoter 104 that evaporates from the liquid sorbent 102 since the promoter is present in the ionic form and therefore has low vapor pressure. In some embodiments, the exhaust gas mixture 114 comprises a moisture content greater than the moisture content in the incoming gas mixture. In some embodiments, at least a portion of the exhaust gas mixture 114 is recycled in to the reactor unit 110.

In some embodiments, the exhaust gas mixture 114 is fed into another unit to trap the moisture in it. In some embodiments, the exhaust gas mixture 114 is fed into another unit where any evaporated portions of the liquid sorbent 102 are recovered by treating the exhaust gas mixture 114 with water or another solvent.

Reactor Unit 110. The reactor unit comprises at least an inlet for the incoming gas mixture 112, an inlet an outlet for the outgoing gas mixture 114, at least an inlet and outlet for the liquid sorbent 102, and a means for facilitating the reaction between the liquid sorbent 102 and the CO₂ in the incoming gas mixture 112. In some embodiments, the reactor unit is one of a cooling tower, a carbonation tower, or an absorption column. In such cases the reaction unit may further comprise a fill material having a large specific surface area providing an interface for the reaction between the liquid sorbent 102 and the CO₂ in the incoming gas mixture 112. In some embodiments, the fill material may be made of a metal, a ceramic, or a polymer.

In some embodiments, the reactor unit 110 is a Continuous Stirred Tank Reactor (CSTR) unit. In some embodiments, the CSTR Unit comprises an inlet and outlet for the liquid sorbent, an inlet for the incoming gas mixture 112, an outlet for the exhaust gas mixture 114, a means for injecting the incoming gas mixture 112 as fine bubbles, and a means for stirring the liquid sorbent 102. In some embodiments, the bubble size in the CSTR is in between about 0.01 microns and 5000 microns. In some embodiments, the bubble size in the CSTR is in between about 0.1 microns and 10 microns. In some embodiments, the bubble size in the CSTR is in between about 1 micron and 100 microns.

In some embodiments, the reactor unit may comprise a means to atomize the liquid sorbent 102 into smaller droplets. In some embodiments, the large surface area created due to the atomized droplets may enhance the dissolution of CO₂ present in the incoming gas mixture 112 into the liquid sorbent 102. In some embodiments, the large surface area created due to the atomized droplets may enhance the reaction of CO₂ present in the incoming gas mixture 112 into the liquid sorbent 102. In some embodiments, the large surface area created due to the atomized droplets may enhance the precipitation of the product 108 formed after the reaction.

In some embodiments, the evaporation of water or other solvent in the atomized droplets causes a reduction in mass and volume of the droplets leading to an increase in concentration of solution in atomized droplets which in turn leads to precipitation of the product 108. In some embodiments, the precipitation of the product 108 occurs in atomized droplets is due to lowering of temperature of the droplet due to evaporation of the water or solvent in the liquid sorbent 102. In some embodiments, the precipitation behavior of the product 108 is different in the atomized droplets compared to the precipitation of product 108 from that of bulk liquid.

In some embodiments, the atomized droplets of liquid sorbent 102 are in the size range between about 0.01 microns and about 1000 microns. In some embodiments, the atomized droplets of liquid sorbent 102 are in the size range between about 0.01 microns and about 0.1 microns. In some embodiments, the atomized droplets of liquid sorbent 102 are in the size range between about 0.01 microns and about 1 micron. In some embodiments, the atomized droplets of liquid sorbent 102 are in the size range between about 0.1 microns and about 10 microns. In some embodiments, the atomized droplets of liquid sorbent 102 are in the size range between about 1 micron and about 10 microns. In some embodiments, the atomized droplets of liquid sorbent 102 are in the size range between about 1 micron and about 100 microns. In some embodiments, the atomized droplets of liquid sorbent 102 are in the size range between about 10 microns and about 100 microns. In some embodiments, the atomized droplets of liquid sorbent 102 are in the size range between about 100 microns and about 500 microns. In some embodiments, the atomized droplets of liquid sorbent 102 are in the size range between about 100 microns and about 500 microns.

In some embodiments, such a reactor unit may further comprise a means to prevent the drift of the atomized droplets along with the exhaust gas mixture 114 (for e.g. a drift eliminator). In some embodiments, the reactor unit further comprises a means to condense the atomized droplets. In some embodiments, the reactor unit further comprises a means to condense the moisture contained in the exhaust gas mixture 114.

Temperature range of operation: The temperature range for the operation of the reactor unit 110 may be between about −40° C. and about 100° C. In some embodiments, the temperature of operation of the reactor unit 110 is the temperature of the ambient air. In some embodiments, the temperature of operation of the reactor unit is between about −40° C. and about −20° C. In some embodiments, the temperature of operation of the reactor unit is between about −20° C. and about 0° C. In some embodiments, the temperature of operation of the reactor unit is between about 0° C. and about 25° C. In some embodiments, the temperature of operation of the reactor unit is between about 25° C. and about 40° C. In some embodiments, the temperature of operation of the reactor unit is between about 40° C. and about 80° C. In some embodiments, the temperature of operation of the reactor unit is between about 80° C. and about 100° C. In some embodiments, where the temperature of operation of the reactor unit 110 is under 0° C., an antifreeze compound may be added to the liquid sorbent 102 to prevent its freezing under sub-zero conditions. In some embodiments, the antifreeze compound may be at least one of glycerol, propylene carbonate, ethylene glycol, propylene glycol, or combinations thereof. In some embodiments, where the temperature of operation of reactor unit 110 is under 0° C., a portion of the liquid sorbent 102 may be allowed to be frozen in-situ in order to precipitate the product 108.

In some embodiments, the pressure of operation of the reactor unit 110 is performed around the atmospheric pressure at sea level. In some embodiments, the pressure of operation of the rector unit 110 is performed around the atmospheric pressure at the elevation of the particular location of the reactor unit 110. In some embodiments, the pressure of operation of the rector unit 110 is in the range between about 0.05 M Pa and about 10 M Pa. In some embodiments, the pressure of operation of the reactor unit 110 is in the range between about 0.05 M Pa and about 0.1 M Pa. In some embodiments, the pressure of operation of the rector unit 110 is in the range between about 0.1 M Pa and about 0.2 M Pa. In some embodiments, the pressure of operation of the rector unit 110 is in the range between about 0.2 M Pa and about 0.3 M Pa. In some embodiments, the pressure of operation of the rector unit 110 is in the range between about 0.3 M Pa and about 0.5 M Pa. In some embodiments, the pressure of operation of the rector unit 110 is in the range between about 0.5 M Pa and about 1 M Pa. In some embodiments, the pressure of operation of the rector unit 110 is in the range between about 1 M Pa and about 10 M Pa.

In some embodiments, the pressure of operation is at least about 0.1 M Pa. In some embodiments, the pressure of operation is at least about 0.2 M Pa. In some embodiments, the pressure of operation is at least about 0.5 M Pa. In some embodiments, the pressure of operation is at least about 1 M Pa. In some embodiments, the pressure of operation is at least about 5 M Pa. In some embodiments, the pressure of operation is at most about 5 M Pa. In some embodiments, the pressure of operation is at most about 1 M Pa. In some embodiments, the pressure of operation is at most about 0.5 M Pa. In some embodiments, the pressure of operation is at most about 0.2 M Pa. In some embodiments, the pressure of operation is at most about 0.1 M Pa.

In some embodiments, the reactant 106 and the promoter 104 work synergistically to have an accelerated absorption and reaction of CO₂ present in the incoming gas mixture 112 to form an alkali metal bicarbonate 108 while the promoter 104 remains unchanged.

In some embodiments, the reactant 106 and the amine carbamate promoter 104 work synergistically to have an accelerated absorption and reaction of CO₂ present in the incoming gas mixture 112 to form an alkali metal bicarbonate 108 while the amine carbamate 104 remains unchanged. In other words, the amine carbamate 104 acts as a promoter to enhance the absorption of CO₂ into the liquid sorbent 102.

In some embodiments, the carbamate anions from the promoter 104 work synergistically with carbonate ions from reactant 106 to have an enhanced rate of reactive absorption of CO₂ present in the incoming gas mixture 112. In some embodiments, the cation component of the carbamate salt as promoter 104 works synergistically with carbonate ions from reactant 106 to have an enhanced rate of reactive absorption of CO₂ present in the incoming gas mixture 112 leading to formation of alkali metal bicarbonate.

In some embodiments, the both the carbamate anions and the cation component of the carbamate salt as promoter 104 work synergistically with carbonate ions from reactant 106 to have an enhanced rate of reactive absorption of CO₂ present in the incoming gas mixture 112, leading to formation of the alkali metal bicarbonate.

In some embodiments, the reactant 106 and the promoter 104 in solution may first react to form a chemical species which further enhances the rate of reactive absorption of CO₂ into the liquid sorbent 102.

In some embodiments, the solution 116 comprises seed particles, the seed particles including at least one of sodium bicarbonate, calcium carbonate, magnesium carbonate, silica, an aluminosilicate, calcium silicate, magnesium silicate. These seed particles enhance the rate of precipitation of sodium bicarbonate from the solution.

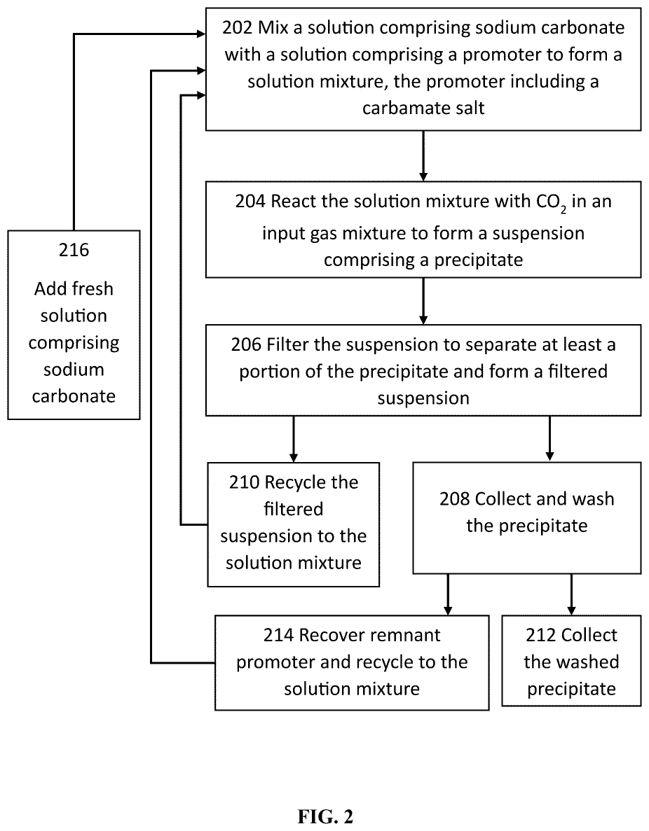

FIG. 2 shows a process flow diagram of continuous process for reactive absorption and mineralization of CO₂ from an incoming gas mixture into a solution comprising sodium carbonate and a promoter. In this continuous process, the product formed by mineralization as a precipitate is filtered out and an additional solution comprising sodium carbonate is added to the initial solution mixture.

In the step 202, a solution 202a comprising sodium carbonate is mixed with a solution comprising a promoter 202b to form a solution mixture 202c. In some embodiments, promoter includes a fully carbonated amine. In some embodiments, the solution comprising a promoter does not include any uncarbonated amine. The promoter 202b may the same as the promoter 104 described in previous sections, and all the characteristics and variations of promoter 104 are applicable to promoter 202b.

The solution 202a comprising sodium carbonate is similar to that described for reactant solution 106 as described in the previous sections. In some embodiments, the solution comprising sodium carbonate is formed by dissolving the mineral trona in water. In some embodiments, the solution comprising sodium carbonate is formed by dissolving another mineral comprising sodium carbonate. In some embodiments, the solution comprising sodium carbonate is formed by dissolving sodium sesquicarbonate in water. In some embodiments, the solution comprising sodium carbonate further includes an equal or lower concentration of sodium bicarbonate in solution.

In some embodiments, the solution comprising sodium carbonate is obtained by solution mining of a mineral bedrock comprising trona. In some embodiments, the mineral bedrock comprising trona may further include other minerals such as a halite, shortite, nahcolite, wegscheiderite, a sodium sulfate bearing mineral, or combinations thereof. In some embodiments, the mineral bedrock comprising trona further includes marlstone, oil shale, and mudstone.

In some embodiments, the mineral bedrock comprising sodium carbonate further includes a borate compound, an arsenate compound, a vanadate compound, or combinations thereof. In some embodiments, the minerals and compounds found alongside the sodium carbonate mineral are water soluble. In some embodiments, the minerals and compounds found alongside the sodium carbonate mineral enhance the rate of reactive absorption of CO₂ into the solution formed by dissolving the sodium carbonate mineral.

In the step 204, the solution mixture 202c is reacted with CO₂ in an input gas mixture to form a suspension comprising a precipitate 204a. This step is similar to the carbonation reaction described in the previous sections along with all the variations. The step 204 occurs is a reactor which is similar to that described in previous sections for the reactor unit 110 along with all the variations. In some embodiments, the reaction step 204 lead to formation of a precipitate 204a which is similar to that described for the product 108 as described in the previous sections.

In step 206, the suspension comprising the precipitate 204a is filtered to remove at least a portion of the precipitate, resulting in the formation of a filtered suspension that has lesser amount of precipitate particles in the suspension compared to the input. The filtration process can be performed in an industrial scale filtration system. The separation of precipitate particles from the suspension can be performed by sedimentation, centrifugal separation, membrane separation, flocculation, or electrostatic separation.

In step 208, the precipitate 204a so separated is collected and washed with a solvent to separate the promoter and other impurities from the precipitate. The solvent is chosen such that it dissolves the promoter but does not dissolve the sodium bicarbonate. In some embodiments, the solvent is an organic solvent miscible with water. In some embodiments, the solvent is at least one of ethanol, methanol, glycerol, ethylene glycol, propylene glycol, propylene carbonate, or combinations thereof. In step 214, the washed solution comprising the dissolved promoter is then recycled back to the solution mixture 202c, while the washed precipitate is collected in step 212 to be sent for either utilization or storage (either geological, sub-surface, or surficial).

In step 210, the filtered suspension obtained after the filtration/separation step 206 is recycled into the solution mixture 202c to undergo further reactive absorption and mineralization of CO₂. A predetermined amount of a solution comprising sodium carbonate is added to the solution mixture 202c in the step 216 to make up for the sodium bicarbonate that is formed in the step 204 due to the reactive absorption of CO₂ from the input gas mixture into the solution mixture 202c.

While not explicitly shown in the FIG. 2, an additional amount of water is added to the solution mixture before the reactive absorption of CO₂ from the incoming gas mixture to make up for the water lost due to evaporation in the previous cycle. In some embodiments, when the step 204 is conducted with direct air in a cooling tower, a 0.5% to 3% loss of water is expected due to evaporation and therefore, an equivalent amount of makeup water is added in the next cycle. The amount of water loss due to evaporation is dependent on a variety of factors such as temperature, humidity, pressure, air flow rate, specific surface area of fill material, flow rate of solution mixture etc.

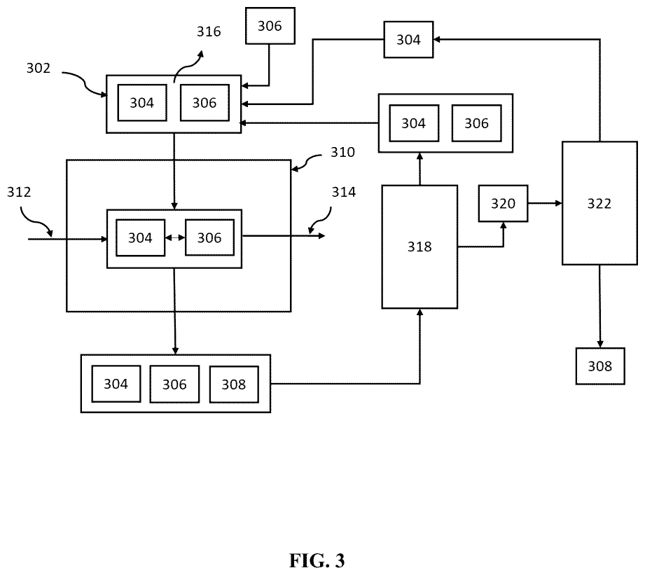

FIG. 3 shows a block diagram equivalent of the process shown in FIG. 2. The elements 302 to 316 correspond to the respective elements 102 to 116 shown in FIG. 1 whose description have been provided in detail in previous sections along with their variations. The suspension obtained after the reactive absorption of CO₂ in the reactor 310 undergoes filtration/separation in the filtration unit 318. The precipitate 320 then undergoes washing and further processing in the promoter recovery unit 322 to obtain a pure precipitate of sodium bicarbonate 308. The recovered promoter 304 is then recycled back into the solution mixture comprising sodium carbonate and promoter.

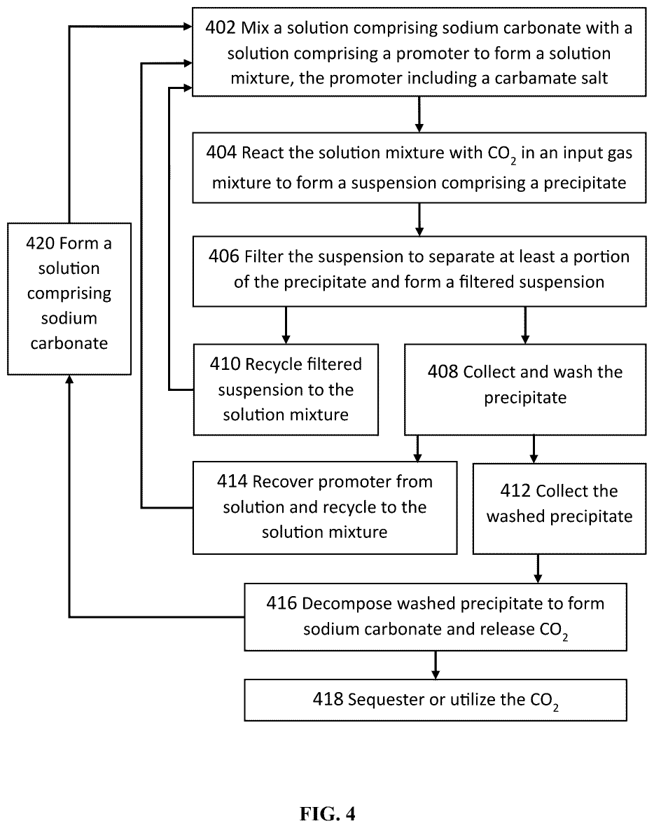

FIG. 4 shows a process flow diagram of a process of production of an output gas stream comprising a high concentration of CO₂. The process is a variation of the process shown in FIG. 2. The process steps 402 to 414 are the same as the process steps 203 to 214 as described in previous sections along with their variations. As a follow-up of the step 412, the washed precipitate (sodium bicarbonate or sodium sesquicarbonate) is decomposed in step 416 to obtain sodium carbonate along with the release of CO₂. In some embodiments, the decomposition process can be performed by imparting thermal energy via a variety of methods, for example, heating via burning of natural gas in a rotary kiln, indirect heating, or passing steam through the precipitate. In some embodiments, the decomposition of the precipitate can be achieved by electrochemical means wherein the precipitate is dissolved in water and then electric current is passed through the solution at a prerequisite voltage to convert the sodium bicarbonate into sodium carbonate.

In some embodiments, the decomposition of sodium bicarbonate may be achieved by chemical means. For example, the sodium bicarbonate can be reacted in a solution or a slurry with sodium hydroxide to form sodium carbonate. In this case, no CO₂ is released and therefore a subsequent step 418 is not needed. The sodium bicarbonate may also be reacted with an alkaline earth metal hydroxide such as calcium hydroxide or magnesium hydroxide to form sodium carbonate.

In some embodiments, wherein CO₂ is released by decomposition of sodium bicarbonate, a subsequent step 418 is performed wherein the released gas is compressed and transported for injection into an underground storage site. In some embodiments, the released CO₂ is utilized in step 418 for making chemicals or a variety of other products.

The sodium carbonate or the sodium carbonate solution produced in step 416 is then formed into a solution with a predetermined concentration of solids by weight in step 420 and mixed with the solution mixture in step 402 to repeat the process. The process 400 therefore is a closed loop process for production of output gas mixtures having a high CO₂ concentration from an incoming gas mixture having a low concentration of CO₂ such as ambient air or an exhaust of an industrial process.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of reactive absorption of CO₂ from gas mixtures, the method comprising:
mixing a solution comprising alkali metal carbonate with a fully carbonated amine to form a solution mixture; and
reacting a portion of the solution mixture with an input gas mixture comprising CO₂.

2. The method of claim 1, wherein the fully carbonated amine enhances the rate of reactive absorption of CO₂ into the alkali metal carbonate.

3. The method of claim 1, wherein the amine is chosen from a list comprising monoethanolamine, diethanolamine, diglycolamine, methyldiethanolamine, 2-amino-2-methyl-1-propanol, diisopropanolamine, triethanolamine, and piperazine.

4. The method of claim 1, wherein the percentage of CO₂ in the input gas mixture is in range between about 0.001% and about 50%.

5. The method of claim 1, wherein the input gas mixture is ambient air.

6. The method of claim 1, wherein the alkali metal carbonate is at least one of sodium carbonate, potassium carbonate, or their combination.

7. The method of claim 1, wherein the reaction of solution mixture with the input gas mixture leads to formation of a precipitate, the precipitate including alkali metal bicarbonate.

8. A composition for reactive absorption of CO₂, the composition comprising:
an aqueous solution of an alkali metal carbonate; and
a promoter including a carbamate salt dissolved in the aqueous solution.

9. The method of claim 8, wherein the carbamate salt enhances the rate of reactive absorption of CO₂ into the alkali metal carbonate.

10. The method of claim 8, wherein the carbamate anion of the carbamate salt includes at least one of a primary carbamate anion, a secondary carbamate anion, or a tertiary carbamate ion.

11. The method of claim 8, wherein the cation of the carbamate salt includes a metal ion, a primary ammonium ion, a secondary ammonium ion, a tertiary ammonium ion, or a quaternary ammonium ion.

12. The method of claim 8, wherein the carbamate salt is formed by carbonation of an amine.

13. The method of claim 12, wherein the amine is chosen from a list comprising monoethanolamine, diethanolamine, diglycolamine, methyldiethanolamine, 2-amino-2-methyl-1-propanol, diisopropanolamine, triethanolamine, and piperazine.

14. The composition of claim 8, wherein the promoter does not include any uncarbonated amine.

15. A method of continuous capture and mineralization of CO₂, the method comprising:
mixing a solution comprising trona with a fully carbonated amine to form a solution mixture;
reacting the solution mixture with CO₂ in ambient air to form a suspension comprising a precipitate, the precipitate including sodium bicarbonate;
filtering the suspension to separate at least a portion of the precipitate and form a filtered suspension; and
recycling the filtered suspension to the solution mixture, and adding fresh trona solution to the solution mixture.

16. The method of claim 15, wherein the full carbonated amine enhances the rate of reactive absorption of CO₂ into the trona solution.

17. The method of claim 15, wherein the full carbonated amine forms a carbamate anion in solution, the carbamate anion including a primary carbamate anion, a secondary carbamate anion, or a tertiary carbamate anion.

18. The method of claim 15, wherein the full carbonated amine forms a cation in solution, the cation including a primary ammonium ion, a secondary ammonium ion, a tertiary ammonium ion, or a quaternary ammonium ion.

19. The method of claim 15, wherein the amine is chosen from a list comprising monoethanolamine, diethanolamine, diglycolamine, methyldiethanolamine, 2-amino-2-methyl-1-propanol, diisopropanolamine, triethanolamine, and piperazine.

20. The method of claim 15, wherein the solution mixture does not include any uncarbonated amine.
